(19) United States
(12) Patent Application Publication
(10) Pub. No.: US 2009/0132252 A1
(43) Pub. Date: May 21, 2009

(54) Unsupervised Topic Segmentation of Acoustic Speech Signal

(75) Inventors: Igor Malioutov, Brookline, MA (US); Alex Park, Watertown, MA (US)

Correspondence Address: BROMBERG & SUNSTEIN LLP, 125 SUMMER STREET, BOSTON, MA, 02110-1618, US

(73) Assignee: MASSACHUSETTS INSTITUTE OF TECHNOLOGY, Cambridge, MA (US)

(21) Appl. No.: 11/942,900

(22) Filed: Nov. 20, 2007

(51) Int. Cl. G10L 13/00

(52) U.S. Cl. 704/258; 704/E13.001

(57) ABSTRACT

Disclosed methods and apparatus segment a signal, such as an acoustic speech signal, into coherent segments, such as coherent topics. In the case of an acoustic speech signal, the segmentation relies on only raw acoustic information and may be performed without requiring access to, or generation of, a transcript of the acoustic speech signal. Recurring acoustic patterns are found by matching pairs of sounds, based on acoustic similarity. Information about distributional similarity from multiple local comparisons is aggregated and is further processed to fill gaps in the data by growing regions that represent recurring acoustic patterns. Selection criteria are used to identify coherent topics represented by the grown regions and topic boundaries therebetween. Another signal, such as a video signal, may be partitioned according to topic boundaries identified in an acoustic speech signal that is related to the video signal. Other (non-acoustic) one-dimensional signals, such as electrocardiogram (EKG) signals, may be automatically segmented into parts, such as parts that relate to normal and to abnormal heart beats.

### STATEMENT REGARDING FEDERALLY SPONSORED RESEARCH OR DEVELOPMENT

This invention was made possible with government support by the National Science Foundation under grants DGE 0645960 and/or IIS 0415865. The U.S. Government has certain rights in the invention.

### TECHNICAL FIELD

The present invention relates to unsupervised segmentation of speech data into topics and, more particularly, to segmenting speech data based on raw acoustic information, without requiring a transcript or performing an intermediate speech recognition step.

### BACKGROUND ART

Topic segmentation refers to partitioning text or speech data into segments, such that each segment contains data related to a single topic. For example, an entire newspaper or news broadcast may be segmented into separate articles. Text, i.e. character data, typically contains discrete words, punctuation, paragraph breaks, section markers and other structural cues that facilitate topic segmentation. These cues are, however, entirely missing from speech data.

A variety of methods for topic segmentation have been developed in the past. These methods typically assume that a segmentation algorithm has access not only to an acoustic input, but also to a transcript of the input, such as an output from an automatic speech recognizer. This assumption is natural for applications where a transcript has to be computed as part of the system output or the transcript is readily available from some other component or source. However, for some domains and languages, transcripts may not be available or recognition performance may not be adequate to achieve reasonable segmentation.

A variety of supervised and unsupervised methods have been employed to segment speech input. Some of these algorithms were originally developed for processing written text. (Georgescul, et al., 2006; Beeferman, et al., 1999.) Others are specifically adapted for processing speech input by adding relevant acoustic features, such as pause length and speaker change. (Galley, et al., 2003; Dielmann and Renals, 2005.) In parallel, researchers extensively studied the relationship between discourse structure and informational variation. (Hirschberg and Nakatani, 1996; Shriberg, et al., 2000.) However, all the existing segmentation methods require as input a speech transcript of reasonable quality.

### SUMMARY OF THE INVENTION

An embodiment of the present invention provides a method for segmenting a one-dimensional first signal into coherent segments. The signal may be an acoustic speech signal, a multimedia signal, an electrocardiogram signal or another type of signal. The method includes generating a representation of spectral features of the signal and identifying a plurality of recurring patterns in the signal using the generated spectral features representation.

The plurality of recurring patterns may be identified as follows. For each of a plurality of pairs of the spectral feature representations, a distortion score corresponding to a similarity between the representations of the pair may be calculated. In addition, a plurality of the pairs of spectral feature representations may be selected based on distortion scores and a selection criterion. The plurality of recurring patterns may be identified by optimizing a dynamic programming objective.

The method also includes aggregating information about a distribution of similar ones of the identified patterns, such as by discretizing the signal into a plurality of time intervals and, for each of a plurality of pairs of the time intervals, computing a comparison score. Identifying the plurality of recurring patterns may include, for each of a plurality of pairs of spectral feature representations of the signal, calculating an alignment score corresponding to a similarity between the representations of the pair. Computing the comparison score may include summing the alignment scores of alignment paths, at least a portion of each of which falls within one of the pair of the time intervals.

The method also includes modifying the aggregated information to enlarge regions representing at least some of the similar identified patterns, such as by reducing score variability within homogeneous regions. This may be accomplished by applying anisotropic diffusion to a representation of the aggregated information.

The method also includes partitioning the signal according to ones of the enlarged regions, such as by applying a process that is guided by a function that maximizes homogeneity within a segment and minimizes homogeneity between segments. The signal may be partitioned by applying a process that is guided by minimizing a normalized-cut criterion.

Optionally, the method includes partitioning the modified aggregated information according to ones of the enlarged regions, and partitioning the signal may include partitioning the signal according to the partitioning of the modified aggregated information.

Optionally, a second signal, such as a video signal, different than the first signal, may be partitioned consistent with the partitioning of the first signal.

The first signal may comprises an acoustic speech signal, and the generating, identifying, aggregating, modifying and partitioning may be performed without access to a transcription of the acoustic speech signal.

Another embodiment of the present invention provides a computer program product. The computer program product includes a computer-readable medium on which are stored computer instructions. When the instructions are executed by a processor, the instructions cause the processor to generate a representation of spectral features of the signal, identify a plurality of recurring patterns in the signal using the generated spectral features representation, aggregate information about a distribution of similar ones of the identified patterns, modify the aggregated information to enlarge regions representing at least some of the similar identified patterns and partition the signal according to ones of the enlarged regions.

Yet another embodiment of the present invention provides a system for partitioning an input signal into coherent segments. The system includes a feature extractor that is operative to generate a representation of spectral features of the input signal. The system also includes a pattern detector that is operative to identify a plurality of recurring patterns in the signal using the generated spectral features representation. The system also includes a pattern aggregator operative to aggregate information about a distribution of similar ones of the identified patterns. The system also includes a matrix gap filler that is operative to modify the aggregated information to enlarge regions representing at least some of the similar identified patterns. The system also includes a segmenter operative to partition the signal according to ones of the enlarged regions.

### BRIEF DESCRIPTION OF THE DRAWINGS

The invention will be more fully understood by referring to the following Detailed Description of Specific Embodiments in conjunction with the Drawings, of which:

FIG. 1 is an abstract representation of an acoustic input stream;

FIG. 2 is a schematic block diagram of a system for segmenting an acoustic input stream, such as the stream in FIG. 1, into topics, according to one embodiment of the present invention;

FIG. 3 is a pixelated representation of a distortion matrix created from an input stream, such as the stream in FIG. 1, according to one embodiment of the present invention;

FIG. 4 is a pixelated representation of an exemplary similarity matrix, according to the prior art;

FIG. 5 is a pixelated representation of an exemplary acoustic comparison matrix generated from the distortion matrix of FIG. 3 after gaps have been filled, according to one embodiment of the present invention;

FIG. 6 is a flowchart describing the operations performed by the system shown in FIG. 2, according to one embodiment of the present invention;

FIG. 7 is a more detailed flowchart describing some of the operations described in FIG. 6, according to one embodiment of the present invention;

FIG. 8 schematically illustrates a short-time Fourier transformation process performed in FIG. 7, according to one embodiment of the present invention;

FIG. 9 schematically illustrates a scaling/rotational transformation performed in FIG. 7, according to one embodiment of the present invention;

FIG. 10 is a more detailed flowchart describing some of the operations described in FIG. 6, according to one embodiment of the present invention;

FIG. 11 is a schematic diagram of an alignment matrix and a process for filling in the alignment matrix, according to one embodiment of the present invention;

FIG. 12 is a schematic diagram of the alignment matrix of FIG. 11, illustrating an exemplary alignment path fragment and its distortion profile, according to one embodiment of the present invention;

FIG. 13 is an oblique view of an exemplary distortion profile plot, shown relative to the alignment matrix of FIG. 11;

FIG. 14 is an exemplary histogram of alignment path fragment lengths and a threshold selected therefrom, according to one embodiment of the present invention;

FIG. 15 is a schematic diagram of a process for generating an acoustic comparison matrix, according to one embodiment of the present invention;

FIG. 16 is a flowchart that summarizes operations for generating an acoustic comparison matrix, according to one embodiment of the present invention;

FIG. 17 is a schematic illustration of an example of a single step of anisotropic diffusion from a cell to the cell's nearest neighbors, according to the prior art;

FIGS. 18 and 19 schematically illustrate partitioning a graph, according to one embodiment of the present invention; and

FIG. 20 is a flowchart that summarizes operations for selecting an optimum path through an alignment matrix, according to one embodiment of the present invention.

### DETAILED DESCRIPTION OF SPECIFIC EMBODIMENTS

Methods and apparatus are disclosed for segmenting an acoustic speech signal into coherent topic segments, without requiring access to, or generation of, a transcript of the acoustic speech signal. The disclosed unsupervised topic segmentation relies on only raw acoustic information. The systems and methods analyze a distribution of recurring acoustic patterns in an acoustic speech signal. The central hypothesis is that similar sounding acoustic sequences correspond to similar lexicographic sequences. Thus, by analyzing the distribution of acoustic patterns, the disclosed systems and methods approximate a traditional content analysis based on a lexical distribution of words in a transcript, but without requiring automatic speech recognition or any other form a lexical analysis.

The recurring acoustic patterns are found by matching pairs of sounds, based on acoustic similarity. The systems and methods are driven by changes in the distribution of the found acoustic patterns. The systems and methods robustly handle noise inherent in the matching process by intelligently aggregating information about distributional similarity from multiple local comparisons. Nevertheless, data about the recurring acoustic patterns are typically too sparse to identify coherent topics or topic boundaries. The information about the distribution of the acoustic patterns is further processed to fill in missing information (“gaps”) in the data by growing regions that represent recurring acoustic patterns. Selection criteria are used to identify coherent topics represented by the grown regions and topic boundaries therebetween.

By extension, the disclosed methods and systems may be used to segment any one-dimensional signal, such as a time-varying signal into coherent portions. The segmentation need not be related to topics. Instead, the signal may be segmented into portions related to different parts of the signal. For example, an electrocardiogram (EKG) may be automatically segmented into parts related to a resting period, a period of exertion, a heart attack period or a period of arterial fibrillation or another abnormal heart beat. In one embodiment, a system alerts a patient or a doctor in real time of a detected abnormal heart beat. In another embodiment, a system analyzes a previously recorded EKG signal.

### Definitions

As used in this description and accompanying claims, the following terms shall have the meanings indicated below, unless context requires otherwise:

coherent—containing related contents; for an acoustic speech signal, containing speech data related to a single topic; for a non-speech signal, related contents means the signal can be described as being associated with a single characteristic, event, source, circumstance or the like

distortion—a quantified spectral difference between two segments of a signal

similarity—opposite of distortion; a similarity between two segments of a signal may be represented by a difference between the spectral difference between a distortion-free (i.e., identical) pair of segments and a distortion between the two segments, i.e., 1.0-D, where D is the distortion value between the two segments

### Introduction

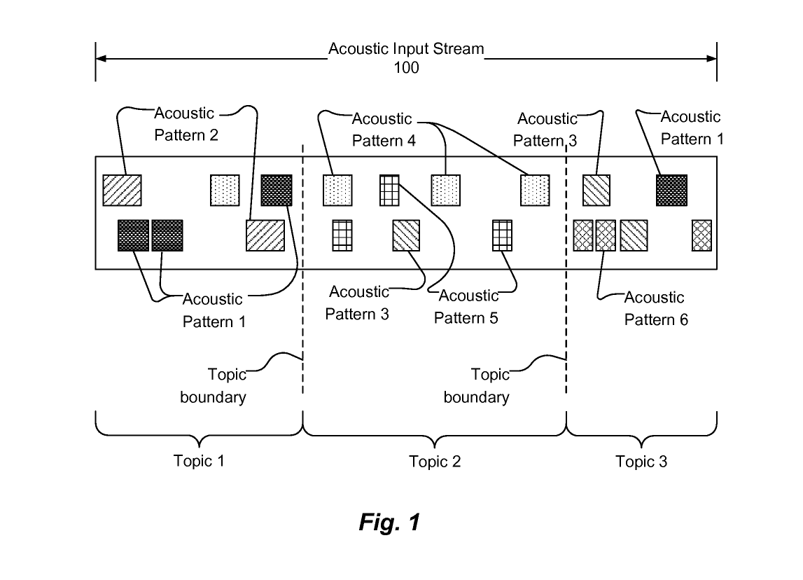

Embodiments may be used to segment various types of signals. An exemplary embodiment for segmenting an acoustic speech signal into coherent topic segments is described in detail. However, the principals disclosed in relation to this acoustic embodiment are also applicable to other embodiments. As noted, the disclosed systems and methods are driven by changes in the distribution of patterns in an input signal. FIG. 1 is an abstract representation of an acoustic input stream 100, such as an audio recording of a physics lecture. Assume the acoustic input stream 100 consists of three topics: Topic 1, Topic 2 and Topic 3. During each topic, the acoustic input stream 100 contains characteristic acoustic patterns that are repeated within the topic. For example, during Topic 1, Acoustic Pattern 1 occurs three times, and Acoustic Pattern 2 occurs twice. Similarly, during Topic 2, Acoustic Pattern 4 occurs three times, and Acoustic Pattern 5 occurs three times. During Topic 3, Acoustic Pattern 3 occurs twice, and Acoustic Pattern 6 occurs three times. For simplicity of explanation, FIG. 1 shows a limited number of acoustic patterns. The actual number of acoustic patterns may be far greater than the number shown in FIG. 1.

A boundary between Topic 1 and Topic 2 may be inferred by a change in the distribution of the acoustic patterns. For example, it can be seen that Acoustic Patterns 1 and 2 occur primarily during Topic 1, whereas Acoustic Patterns 4 and 5 occur primarily during Topic 2. The acoustic patterns may, however, also occur during other topics. For example, Acoustic Pattern 1 also occurs during Topic 3.

Nevertheless, combinations of findings may be used to draw or strengthen an inference of a boundary. For example, the following combination of evidence may be used to infer a boundary between two portions (topics) of the acoustic stream 100: (a) a number of occurrences of a particular acoustic pattern (such as Acoustic Pattern 1) during one portion (such as Topic 1) of the acoustic input stream 100; (b) few or no occurrences of the same acoustic pattern during a temporally proximate portion (such as Topic 2) of the acoustic input stream 100; and (c) a number of occurrences of a different acoustic pattern (such as Acoustic Pattern 4) during the temporally proximate portion (Topic 2) of the acoustic input stream 100. This inference may be strengthened by a number of occurrences of yet another acoustic pattern (such as Acoustic Pattern 2) within one portion (Topic 1) and a number of occurrences of a different acoustic pattern (such as Acoustic Pattern 5) within the other portion (Topic 2) of the acoustic input screen 100. Thus, a change in the distribution of the acoustic patterns may be used to signal a boundary between topics.

The disclosed systems and methods detect recurring acoustic patterns within an acoustic input stream and aggregate information about the distribution of the detected acoustic patterns to infer topic boundaries. First, the recurring acoustic patterns are identified, and distortion scores between pairs of the patterns are computed. These recurring acoustic patterns correspond to words, phrases or portions thereof that occur with high frequency in the acoustic input stream. However, these high-frequency words, etc. cover only a fraction of the words or phrases that appear in the acoustic input stream. As a result, there are too few acoustic matches obtained during this process to identify proximate topic boundary matches. Thus, due to the distribution and temporal separation of the acoustic patterns, as well as inaccuracies with which recurring acoustic patterns can be identified, simply locating some or all of the recurring acoustic patterns is insufficient to accurately partition the input stream 100 into topics.

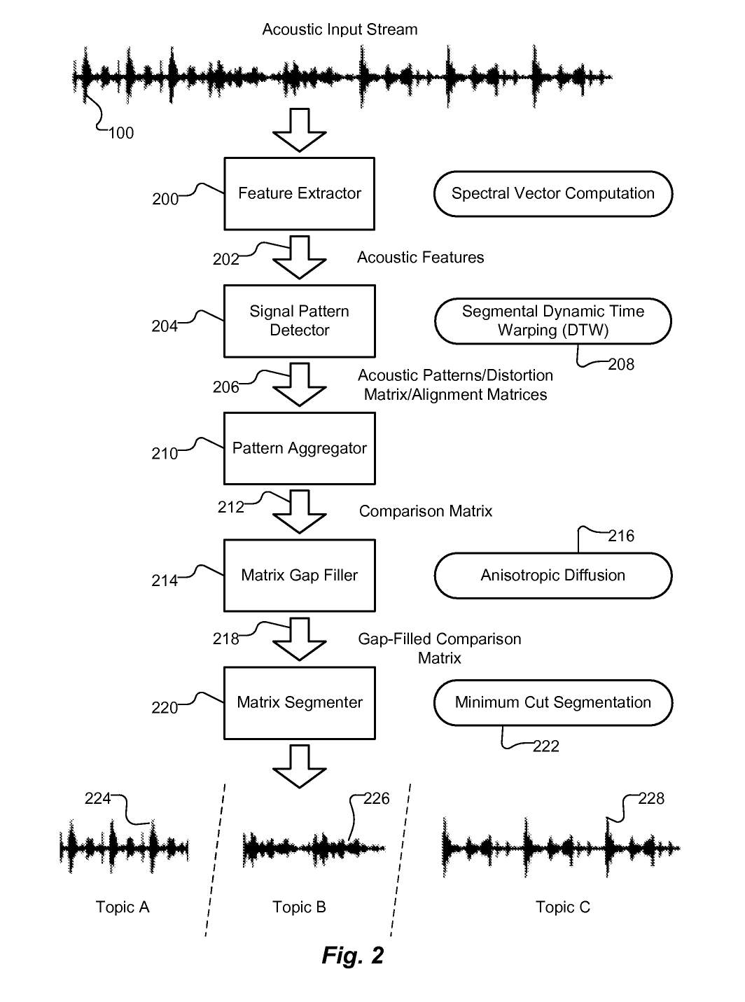

To solve this problem, an acoustic comparison matrix is generated to aggregate information from multiple pattern matches, and additional matrix transforms are performed on the acoustic comparison matrix. These transforms include recursively growing coherent regions in the acoustic comparison matrix and partitioning the resulting matrix to identify segments with homogeneous distributions of acoustic patterns. FIG. 2 is a block diagram of a system for segmenting an acoustic input stream into topics. The diagram provides an overview of operations and functions performed by the system to segment the acoustic input stream into topics. Each of these operations is described briefly here and in more detail below.

Initially, a raw acoustic input stream 100 is transformed by a feature extractor 200 into a vector representation to extract acoustic features 202 of the input stream 100. A pattern detector 204 uses the acoustic features 202 to detect acoustic patterns 206 that occur multiple times in the input stream 100. This detection may be performed using segmental dynamic time warping (DTW) 208 or another technique. A match between an acoustic pattern that occurs at one time within the input stream 100 and another acoustic pattern that occurs at another time within the input stream 100 is referred to as an “alignment,” and information about these matches is stored in a set of “alignment matrices.”

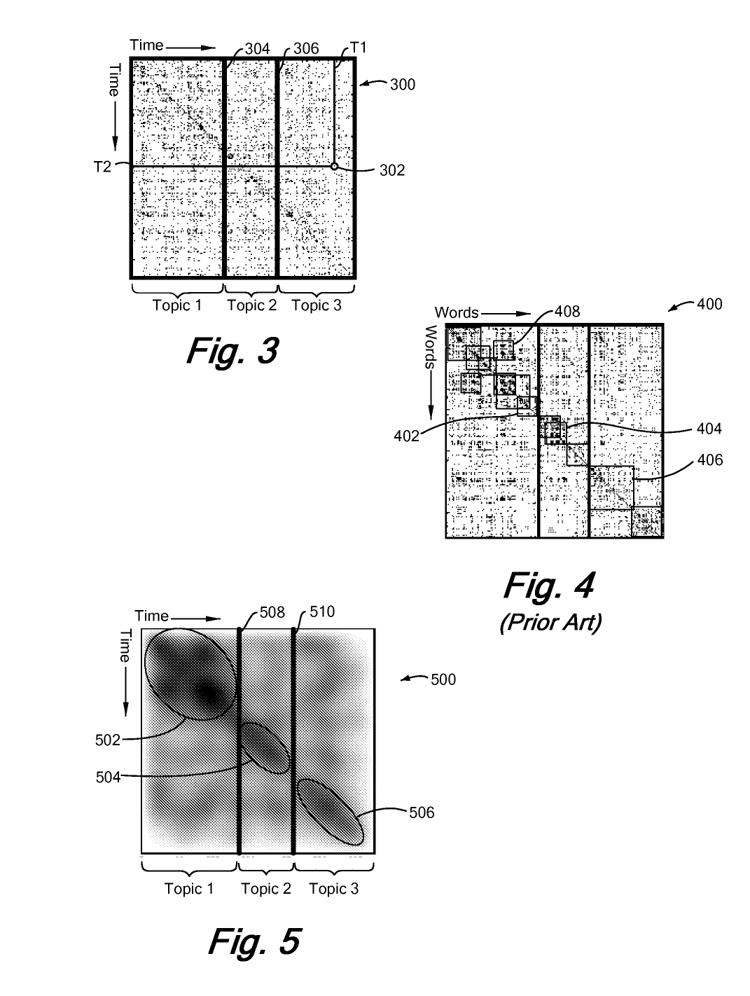

Collectively, information about the recurring acoustic patterns 206 may be represented in a “distortion matrix.” FIG. 3 contains a pixelated representation of a distortion matrix 300 for an acoustic input stream similar to the one referred to in FIGS. 1 and 2, but containing more acoustic patterns than shown in FIG. 1. The distortion matrix 300 was created from an actual recording of a physics lecture.

The horizontal and vertical axes both represent time. Each pixel's darkness is proportional to the similarity (i.e., one minus the distortion) of a repeated acoustic pattern. That is, each pixel's darkness is proportional to the similarity of an acoustic pattern that occurs at a time, represented by the horizontal axis, to another acoustic pattern that occurs at a time represented by the vertical axis. For example, pixel 302 represents the similarity of an acoustic pattern that occurs at time T1 to another acoustic pattern that occurs at time T2. All acoustic patterns are, of course, identical to themselves, which results in a diagonal, downward-slanting line of dark pixels beginning at the upper-left corner (0, 0).

Vertical line 304 represents a boundary between Topic 1 and Topic 2, and vertical line 306 represents a boundary between Topic 2 and Topic 3. The vertical lines 304 and 306 in FIG. 3 have been added merely for explanatory purposes using a priori knowledge of the contents of the recorded physics lecture. As will be seen, the automatic segmentation of the acoustic input stream by the disclosed methods and systems coincides with the manual segmentation represented by lines 304 and 306.

As can be seen in FIG. 3, the distribution and number of the recurring acoustic patterns is typically such that the distortion matrix 300 is sparse. That is, regions (illustrated as pixels or clusters of pixels) representing similar identified patterns may be separated from each other by gaps, even though the regions fall within a single topic. These gaps in the distortion matrix 300 are consistent with gaps between detected acoustic patterns in the acoustic input stream. For example, as can be seen in FIG. 1, the two occurrences of Acoustic Pattern 2 in Topic 1 are separated from each other by a gap. Similarly, two Acoustic Pattern 1 occurrences early in Topic 1 are separated from a later occurrence of Acoustic Pattern 1 in Topic 1. Thus, the distortion matrix 300 may not initially contain information about all time periods within the input stream 100, i.e., the distortion matrix 300 may include time gaps and otherwise lack cues to topic boundaries.

Information about recurring words, phrases, sentences, etc. in a textual document may be stored in a “similarity matrix.” FIG. 4 contains a pixelated representation of a prior-art similarity matrix 400 constructed from a manual transcript of the same physics lecture used to create the distortion matrix 300 discussed above. The horizontal and vertical axes of the similarity matrix 400 represent word counts from the beginning of the transcript. A pixel is black if the words, phrases, sentences, etc. that occur at a time, represented by the horizontal axis, match text that occurs at a time represented by the vertical axis; otherwise the pixel is white. The disclosed systems and methods do not rely on similarity matrices. As noted, a similarity matrix cannot be produced without a transcript, and the disclosed systems and methods do not require transcripts. The similarity matrix 400 is presented here merely so it can be contrasted with the distortion matrix 300.

Unlike the distortion matrix 300 shown in FIG. 3, the similarity matrix 400 immediately reveals blocks, such as blocks outlined by squares at 402, 404, 406 and 408, of groups of identical text. For clarity, not all of the blocks of identical text are outlined in the similarity matrix 400. However, it can be seen that the similarity matrix 400 contains a number of blocks along a diagonal beginning at (0, 0). For reference, vertical lines 410 and 412 identify known topic boundaries, as in FIG. 3.

In contrast to the similarity matrix 400, the distortion matrix 300 shown in FIG. 3 reveals no block structure and, as noted, the distortion matrix 300 may include many time gaps between identified similar acoustic patterns. Thus, unless these gaps are filled, the distortion matrix 300 is unlikely to directly identify topic boundaries. However, the gaps should be filled in a way that does not cause discrete topics to blend together. A pattern aggregator 210 (FIG. 2) builds an acoustic comparison matrix 212 to gather information about detected acoustic matches. Gaps in the comparison matrix 212 are intelligently filled by a matrix gap filler 214 using a set of signal transformations, such as anisotropic diffusion 216, or another suitable technique to create a gap-filled acoustic comparison matrix 218. FIG. 5 contains a pixelated representation of an exemplary acoustic comparison matrix 500 for the physics lecture after 1,000 iterations of anisotropic diffusion; however, other numbers of iterations may be used. The number of iterations may be tuned on a held-out development set, such as three lectures. As in the distortion matrix 300, horizontal and vertical axes represent time, and each pixel's darkness is proportional to the similarity of a repeated acoustic pattern.

Anisotropic diffusion 216 (FIG. 2) modifies the aggregated information to enlarge regions that represent at least some of the similar identified patterns. The enlargement process encourages intra-region diffusion. At the same time, the enlargement process discourages inter-region diffusion, i.e., diffusion across high-gradient boundaries, which likely represent topic boundaries. As can be seen in FIG. 5, this enlargement process creates easily identifiable regions 502, 504 and 506 along a diagonal beginning at (0, 0). Furthermore, these regions 502, 504 and 506 are distinct from each other, and topic boundaries 508 and 510 may be inferred between respective pairs of the regions 502, 504 and 506. Unlike the distortion matrix 300 shown in FIG. 3 and the similarity matrix 400 shown in FIG. 4, the topic boundaries 508 and 510 in FIG. 5 were automatically determined from the regions 502-504, not as a result of a priori knowledge of the contents of the recorded physics lecture. However, it can be seen that the automatically generated topic boundaries 508 and 510 are consistent with the manually generated topic boundaries 304, 306, 410 and 412 in FIGS. 3 and 4.

Returning to FIG. 2, the gap-filled acoustic comparison matrix 218 is segmented by a matrix segmenter 220 using a normalized-cut segmentation criterion 222 to partition the gap-filled acoustic comparison matrix 218 at boundaries between regions that contain similar acoustic patterns. The criterion maximizes intra-segment similarities and minimizes inter-segment similarities. The acoustic input stream 100 is partitioned into topics 224, 226 and 228, according to the partitioning of the gap-filled acoustic comparison matrix 218.

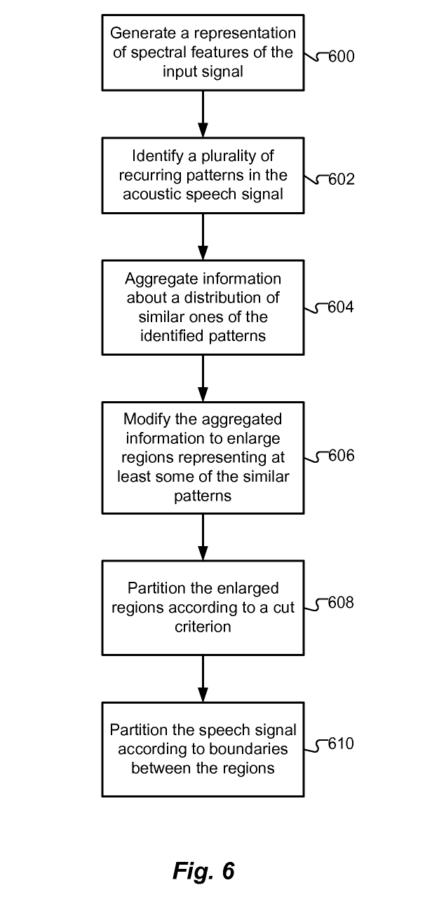

The operations summarized in FIG. 2 are now described with respect to a flowchart in FIG. 6. At 600, a representation of spectral features of the input signal is generated. At 602, a plurality of recurring patterns in the acoustic speech signal is identified. At 604, information about a distribution of similar ones of the identified patterns is aggregated. At 606, the aggregated information is modified to enlarge regions that represent at least some of the similar patterns. At 608, the enlarged regions are partitioned according to a cut criterion. At 610, the acoustic speech signal is partitioned according to boundaries between the enlarged regions. Each of these operations is described in detail below.

### Identifying Recurring Patterns in the Acoustic Speech Signal

The goal of this operation is to identify a set of acoustic patterns that occur frequently in a raw acoustic input stream (an acoustic input signal). Continuous speech includes many word sequences that lack clear low-level acoustic cues to denote word boundaries. Therefore, this task cannot be performed by simply counting speech segments separated from each other by silence. Instead, a local alignment process (which identifies local alignments between all pairs of utterances) is used to search for similar speech segments and to quantify an amount of distortion between them. As noted, distortion means a quantified spectral difference between two audio segments.

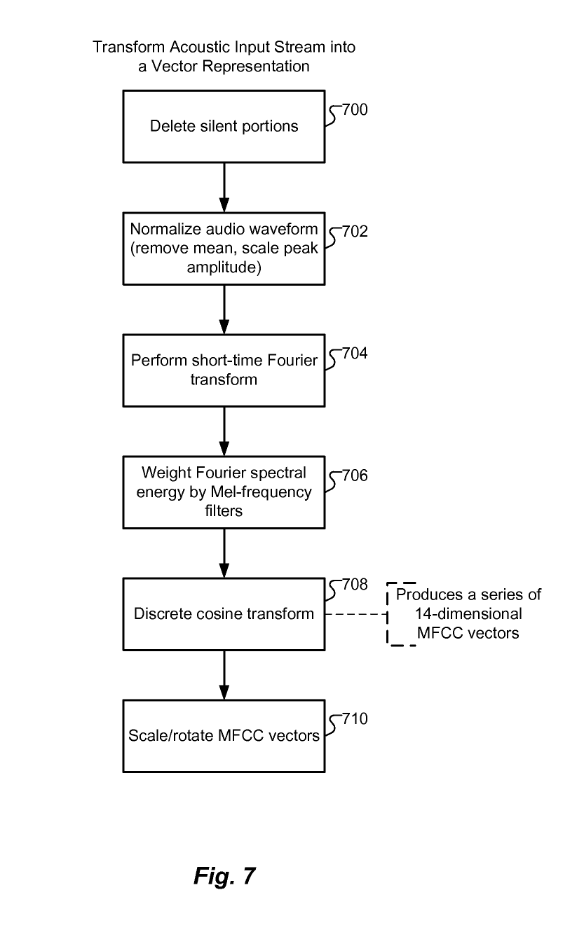

In preparation for executing the local alignment process, the acoustic input signal is transformed, as summarized in the flowchart of FIG. 7, into a vector representation that facilitates comparing acoustic sequences. At 700, the transform deletes silent portions of the acoustic input signal. This operation breaks the acoustic input signal into a series of continuous, spoken utterances, i.e., silence-free utterances. An utterance may be a portion of a word, a word, a phrase, a sentence or more or a portion thereof. Furthermore, an utterance may be completely contained within a single topic or an utterance may span more than one topic.

Silence deletion facilitates eliminating or avoids spurious alignments between silent regions of the acoustic input signal. However, silence detection is not equivalent to word boundary detection, inasmuch as segmentation by silence detection alone may account for only about 20% of word boundaries.

The next few processes shown in FIG. 7 convert each silence-free utterance into a time-series of feature vectors that include Mel-scale cepstral coefficients (MFCCs). This compact, low-dimensional representation is commonly used in speech processing applications, because it approximates human auditory models. To extract MFCCs from the acoustic input signal, a 16 kHz digitized input audio waveform is first normalized by removing the mean amplitude and scaling the peak amplitude, as indicated at 702.

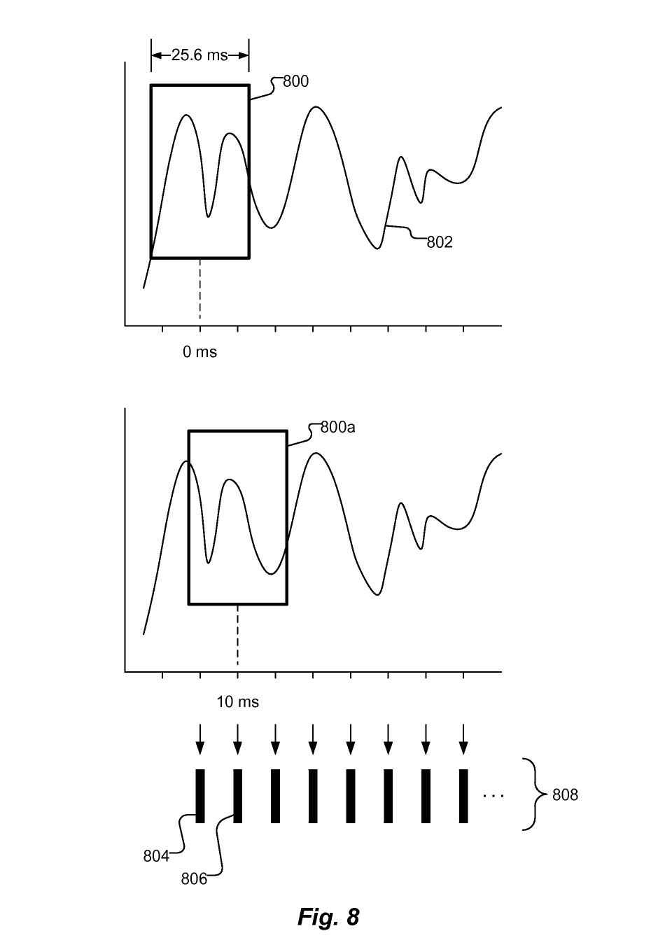

Next, at 704, a short-time Fourier transform is taken at a frame interval of 10 millisecond (ms) using a 25.6 ms Hamming window. This process is illustrated in FIG. 8. In the top portion of FIG. 8, a 25.6 ms Hamming window 800 is shown centered at time 0 ms. The portion of the acoustic input signal 802 within the Hamming window 800 is passed to a Fourier transform. The Fourier transform performs a spectral analysis of the portion of the signal in the window. That is, the Fourier transform analyzes the signal in the window and returns information about the amount of energy present in the signal at each of a set of narrow frequency bands.

The spectral energy from the Fourier transform is then weighted by Mel-scale filters, as indicated at 706 (FIG. 7). (Huang, et al., 2001.) A discrete cosine transform of the log of these Mel-frequency spectral coefficients is computed, as indicated at 708 (FIG. 7), to yield a 14-dimensional MFCC vector 804 (FIG. 8).

The Hamming window 800 is then displaced to the right by 10 ms, as indicated at 800a (in the central portion of FIG. 8), and another MFCC vector 806 is generated from the portion of the acoustic input signal 802 within the displaced Hamming window 800a. This process of displacing the Hamming window by 10 ms and generating another MFCC vector is repeated to produce a series of MFCC vectors 808.

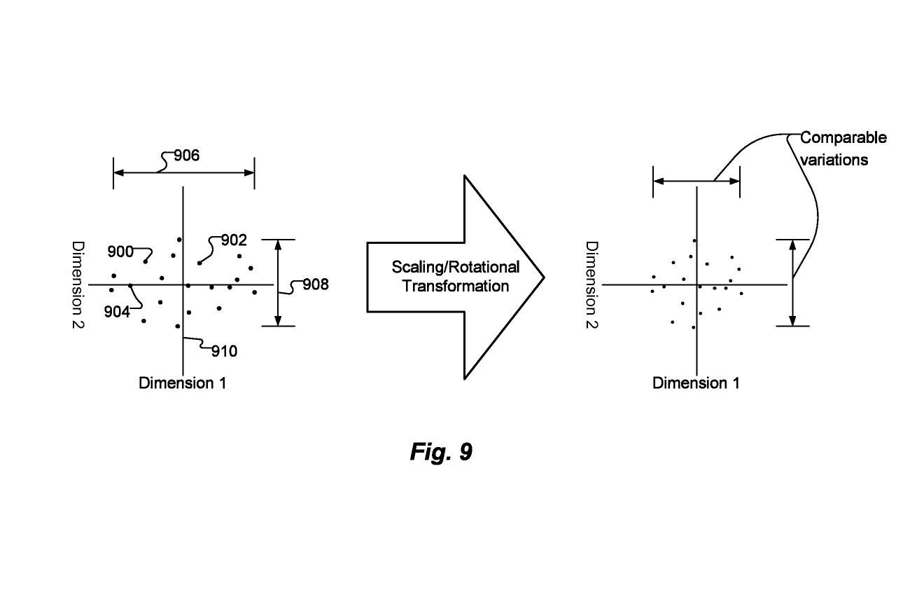

Returning to FIG. 7, the MFCC feature vectors are “whitened” at 710 to normalize variances among the dimensions of the feature vectors and to de-correlate the dimensions of the feature vectors. As noted, the MFCC vectors include information in 14 dimensions. The variances in some of these dimensions are greater than the variances in other of the dimensions. Exemplary variances of two such dimensions are shown in the left portion of FIG. 9. Vectors are depicted as points, such as points 900, 902 and 904. As can be seen, the variance 906 in Dimension 1 is greater than the variance 908 and Dimension 2.

The variance in Dimension 1 may be reduced by rotating the set of vectors about an axis 910 that extends through the center of the set of vectors. As a result, as shown in the right portion of FIG. 9, the variances in Dimension 1 and Dimension 2 are made comparable. After whitening, the distances in each dimension are uncorrelated and have equal variance. Consequently, a difference between two vectors may be determined by calculating an unweighted Euclidean distance between the vectors.

Once the acoustic input stream has been transformed into a vector representation, a local sequence alignment process searches for acoustic patterns that occur multiple times in the input stream and quantifies the amount of distortion between pairs of identified patterns. The patterns may be realized differently; the patterns are more likely to reoccur in varied forms, such as with different pronunciations and/or spoken at different speeds or with different tones or intonations. The alignment process captures this information by extracting pairs of acoustic patterns, each with an associated distortion score.

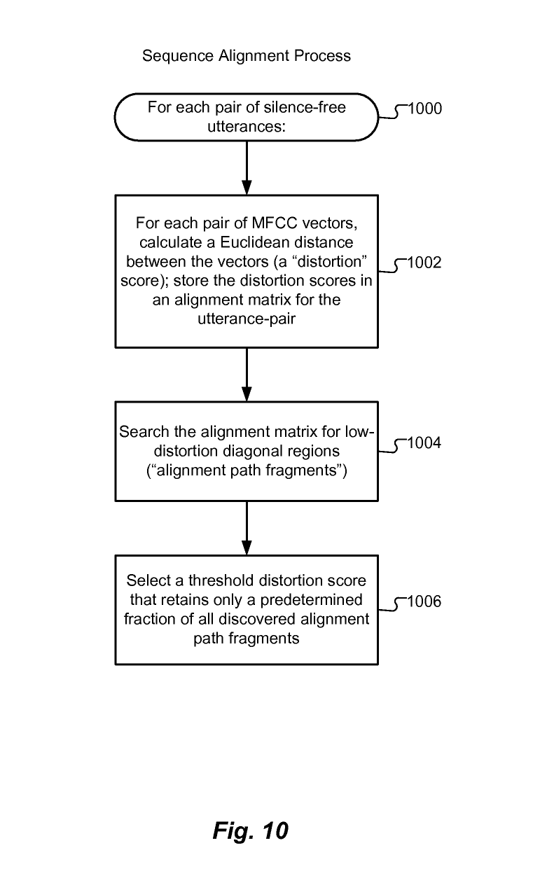

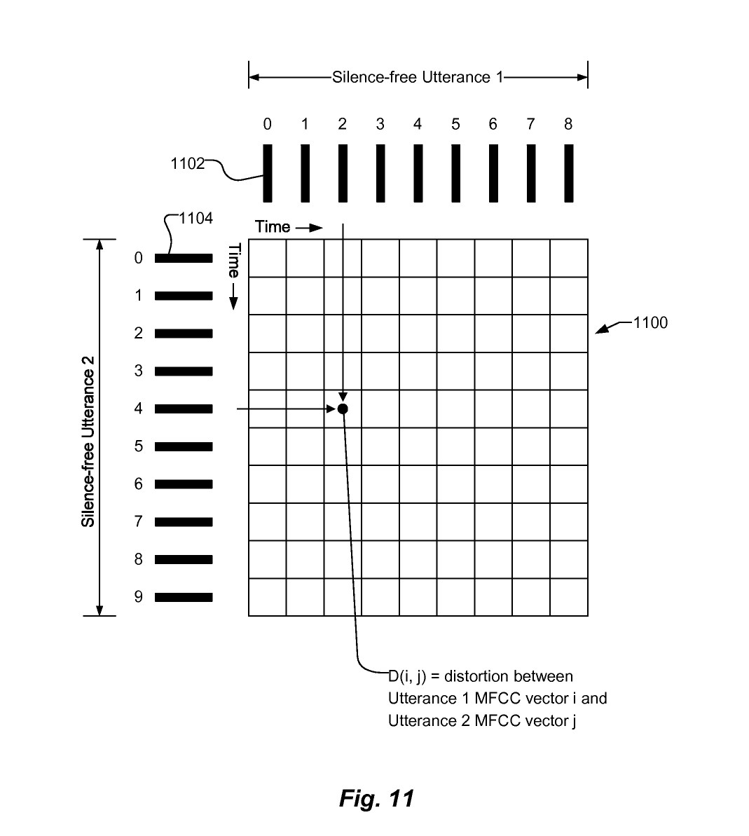

The sequence alignment process is illustrated in a flowchart in FIG. 10. As noted earlier, silent portions of the acoustic input stream are deleted to produce a set of silence-free utterances. As indicated at 1000, the sequence alignment process operates on each pair of silence-free utterances. For each pair of silence-free utterances, the process calculates a set of distortion scores and stores the scores in an alignment matrix. A small, exemplary, alignment matrix 1100 is illustrated in FIG. 11. An alignment matrix may have many more cells than the matrix illustrated in FIG. 11. Note that the alignment matrix 1100 need not be square, because the two silence-free utterances that are being compared may be of unequal lengths. It should also be noted that this sequence alignment procedure produces a number of alignment matrices 1100, one alignment matrix for each pair of silence-free utterances.

As noted, each silence-free utterance is represented by a series of MFCC vectors, such as MFCC vectors 1102 and 1104. A time, relative to the beginning of the acoustic input signal, is stored (or may be calculated) for each MFCC vector. Each distortion score represents a difference between an MFCC vector in the first utterance (referred to as MFCC vector i) and an MFCC vector in the second utterance (referred to as MFCC vector j). As indicated at 1002 (FIG. 10), for each pair of MFCC vectors, the sequence alignment process calculates a Euclidean distance, i.e. a distortion score D(i,j), between the MFCC vectors i and j and stores the distortion (or Euclidian distance) score in the alignment matrix at coordinates (i,j). For example, FIG. 11 illustrates calculating a distortion score between MFCC vector 2 from Silence-free Utterance 1 and MFCC vector 4 from Silence-free Utterance 2 and storing the calculated distortion score in the alignment matrix at coordinates (2, 4). Thus, the Euclidean distance between vector 2 in Silence-free Utterance 1 and vector 4 in Silence-free Utterance 2 is stored in cell (2, 4) of the alignment matrix 1100. Each cell of the alignment matrix 1100 is filled with a distortion score from the pair of MFCC vectors that corresponds to the cell's coordinates within the matrix. Thus, the alignment matrix 1100 is filled with scores; however, many of these scores may indicate little or no similarity, i.e. high distortion.

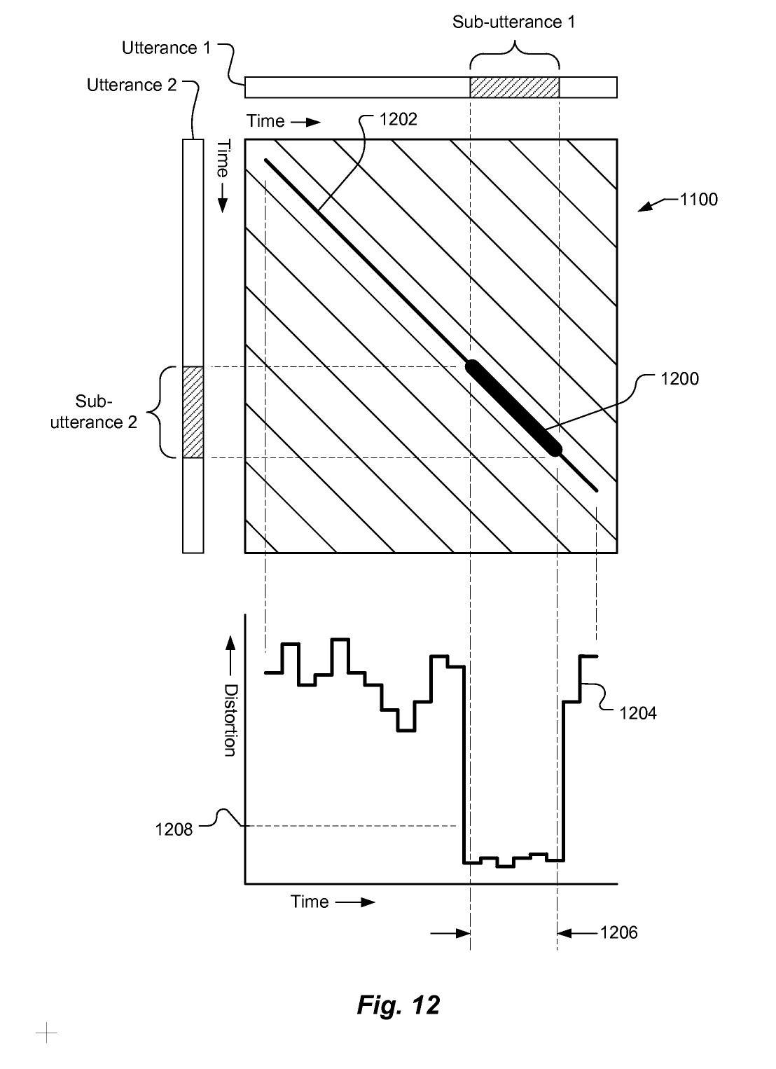

Returning to FIG. 10, once the alignment matrix 1100 has been constructed for a pair of utterances, the sequence alignment process searches the alignment matrix 1100 for low-distortion diagonal regions (“alignment path fragments”), as indicated at 1004. This process is illustrated conceptually in FIG. 12. Each alignment path fragment, such as alignment path fragment 1200, relates a segment of Utterance 1, such as Segment 1, that is similar to a segment of Utterance 2, such as Segment 2. In particular, each alignment path fragment relates a sequence of vectors in Utterance 1, i.e., vectors that constitute Segment 1, to a sequence of vectors in Utterance 2, i.e., vectors that constitute Segment 2.

The length of Segment 1 need not be equal to the length of Segment 2. For example, Segment 2 may have been uttered more quickly than Segment 1. Consequently, the alignment path fragment 1200 need not necessarily lie along a −45 degree angle.

The alignment path fragments should, however, lie along angles close to 45 degrees, because the greater the deviation from 45 degrees, the greater the temporal difference between corresponding vectors (and, therefore, speech rate) between the compared speech segments. It is unlikely that two speech segments that exhibit significant temporal variation from each other are actually lexically similar.

Furthermore, the two segments need not begin or end at the same time as each other, relative to the beginning of their respective utterances or relative to the beginning of the acoustic input signal. However, a beginning and/or ending time of each segment is available from the timing information for the MFCC vectors 1102, 1104, etc. From this information, a beginning and/or ending time coordinate for each alignment path fragment may be looked up or calculated. For example, the beginning time coordinate for alignment path fragment 1200 is (beginning time of Segment 1, beginning time of Segment 2).

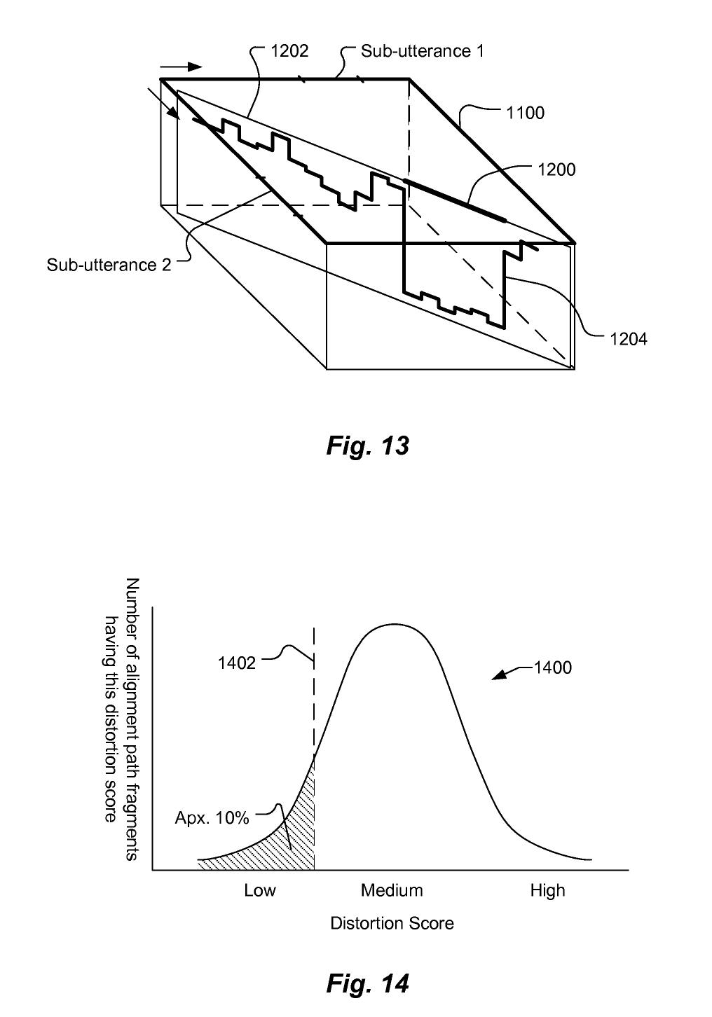

As noted, each cell of the alignment matrix 1100 contains a value that corresponds to a distortion (Euclidian distance) between two vectors. Graphing the distortion values of the cells along a diagonal line, such as line 1202, through the alignment matrix 1100 yields a plot, such as plot 1204 shown in the bottom portion of FIG. 12. (Because the alignment matrix 1100 contains discrete cells, the diagonal line 1202 may actually be a diagonal like path, i.e., a series of right, down steps through the trellis of the alignment matrix 1100. However, for simplicity of explanation, the term “diagonal line” is used, and the average slope of the path will be attributed to the diagonal line.) The plot 1204 provides a “distortion profile” along the diagonal line 1202. Conceptually, the alignment matrix 1100 can be considered a “top-down view” of a set of vertically oriented, distortion profiles stacked next to each other. FIG. 13 illustrates one such vertically oriented distortion profile 1204.

Returning to FIG. 12, assume Segment 1 is acoustically similar to Segment 2. The distortion values along the diagonal line 1202 are relatively low where Segment 1 corresponds to Segment 2, and they are relatively high where Utterance 1 is acoustically dissimilar to Utterance 2. This can be seen in the relative minimum portion 1206 of the plot 1204. For simplicity, the diagonal line 1202 is shown as having only one alignment path fragment 1200; however, a diagonal line may have any number of alignment path fragments, depending on how many segments of Utterance 1 are similar to segments in Utterance 2.

Each alignment path fragment, such as alignment path fragment 1200, is characterized by summing the distortion values along the alignment path fragment and then dividing the sum by the length of the alignment path fragment. Thus, each alignment path fragment is characterized by its average distortion value. This average distortion value summarizes the similarity of the two segments (acoustic patterns, such as Segment 1 and Segment 2) extracted from the two utterances particularly if the two utterances were spoken by the same speaker and during the same lectures, etc.

A variant on Dynamic Time Warping (DTW) (Huang, et al., 2001) is used to find the alignment path fragments. In one embodiment, alignment path fragments that have an average distortion values less than a predetermined threshold (shown at 1208 in FIG. 12) are selected. In another embodiment, the threshold is automatically calculated, as discussed below. As noted, the alignment path fragments need not lie along a −45 degree angle. The alignment path fragments should, however, lie along angles close to −45 degrees, because the greater the deviation from −45 degrees, the greater the temporal difference between corresponding vectors (and, therefore, speech rate) between the compared speech segments. It is unlikely that two speech segments that exhibit significant temporal variation from each other are actually lexically similar.

Dynamic programming or another suitable technique is used to identify the alignment path fragments having lowest average distortions along diagonals within the alignment matrix 1100 (FIGS. 11 and 12). Dynamic programming is a well-known method of solving problems that exhibit properties of overlapping subproblems and optimal substructure. (The word “programming” in “dynamic programming” has no connection to computer programming. Instead, here, “programming” is a synonym for optimization. Thus, the “program” is the optimal plan for action that is produced.) Optimal substructure means that optimal solutions of subproblems can be used to find optimal solutions of the overall problem. The well-known Bellman equation, a central result of dynamic programming, restates the optimization problem in recursive form. For example, the shortest path to a goal from a vertex in a graph can be found by first computing the shortest path to the goal from all adjacent vertices, and then using this information to pick the best overall path. In general, a problem is solved with optimal substructure by a three-step process: (1) break the problem into smaller subproblems; (2) solve these subproblems optimally using this three-step process recursively; and (3) use these optimal solutions to construct an optimal solution for the original problem. The subproblems are, themselves, solved by dividing them into sub-subproblems, and so on, until a simple case, which is easy to solve, is reached.

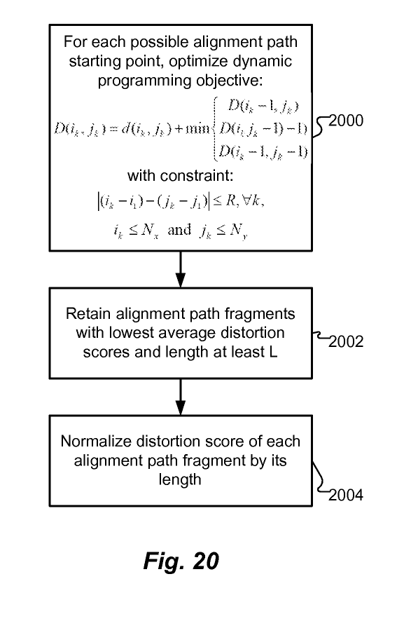

In the disclosed systems and methods, DTW considers various alignment path candidates and selects optimal paths through the alignment matrix 1100, as summarized in a flowchart in FIG. 20. As indicated at 2000, for every possible starting alignment point in the alignment matrix 1100, DTW optimizes the following dynamic programming objective:

$$D ( {i}_{k} , {j}_{k} ) = d ( {i}_{k} , {j}_{k} ) + min \{ \begin{matrix}D ( {i}_{k} - 1 , {j}_{k} ) \\ D ( {i}_{k} {j}_{k} - 1 ) - 1 ) \\ D ( {i}_{k} - 1 , {j}_{k} - 1 )\end{matrix} \qquad ( 1 )$$

In equation (1), iₖ and jₖ are alignment end-points in a k-th subproblem of dynamic programming, and D(a,b) represents a distortion (Euclidean distance) between a and b.

The search process considers not only the average distortion value for a candidate alignment path fragment; the search process also considers the shape of the candidate alignment path fragment. To limit the amount of temporal warping, i.e., to reject candidate alignment path fragments whose angles are markedly different than −45 degrees, the search process enforces the following constraint:

|(iₖ−iₗ)−(jₖ−jₗ)|≦R,∀k, (2)

iₖ≦Nₓ and jₖ≦N_{y} (3)

where Nₓ and N_{y} are the numbers of MFCC frames in each utterance. A diagonal band having a width equal to 2\sqrt{R} controls the extent of temporal warping. The parameter R may be tuned on a development set.

This alignment process may produce paths with high distortion subpaths. As indicated at 2002, to eliminate these subpaths, the process trims each path to retain the subpath with the lowest average distortion and that has a length at least equal to L, which is a predetermined or automatically generated value. This trimming involves finding m and n, given an alignment path fragment of length N, such that:

$${arg min}_{1 \leq m \leq n \leq N} ( \frac{1}{n - m + 1} {\sum }_{k = m}^{n} d ( {i}_{k} , {j}_{k} ) ) , such that n - m \geq L \qquad ( 4 )$$

In other words, select values for m and n that achieve a global minimum for the expression within parentheses in equation (4). Equation (4) keeps the sub-sequence with the lowest average distortion that has a length at least equal to L. For example, given a sequence of distortion values (numbers) n₁, n₂, . . . , nₖ, equation (4) selects a continuous sub-sequence of numbers within this sequence, such that the numbers in the sub-sequence have the lowest average distortion. The parameter L ensures the sub-sequence contains more than a single number. As indicated at 2004, for each alignment path fragment 1200 (FIG. 12) that is retained, its distortion score is normalized by the length of the alignment path fragment 1200.

At 1006 (FIG. 10), the process retains only some of all the discovered alignment path fragments. Alignment path fragments that have average distortions that exceed a threshold are pruned away to ensure the retained aligned word or phrasal units are close acoustic matches. The threshold may be predetermined, entered as a parameter or automatically calculated.

In one embodiment, the threshold distortion value is automatically calculated, such that a predetermined fraction of all the discovered alignment path fragments is retained. For example, as illustrated in FIG. 14, a histogram 1400 of the number of discovered alignment path fragments having various average distortion scores may be used. A threshold distortion value 1402 may be selected, such that about 10% of the discovered alignment path fragments (i.e., the path fragments that have the lowest distortions) are retained. In other embodiments, other percentages may be used.

### Constructing an Acoustic Comparison Matrix

As noted, the sequence alignment process produces a number of alignment matrices, one alignment matrix 1100 (FIGS. 11 and 12) per pair of silence-free utterances, and each alignment matrix may have zero or more alignment path fragments, such as alignment path fragment 1200 (FIG. 12), that are retained. However, also as noted, there are too few acoustic matches in the alignment matrices to identify proximate topic boundary matches. An acoustic comparison matrix is generated to aggregate information from the alignment path fragments and for further processing. Eventually, after further processing that is described below, the acoustic comparison matrix 500 (FIG. 5) facilitates identifying regions, such as regions 502-506, that correspond to topics.

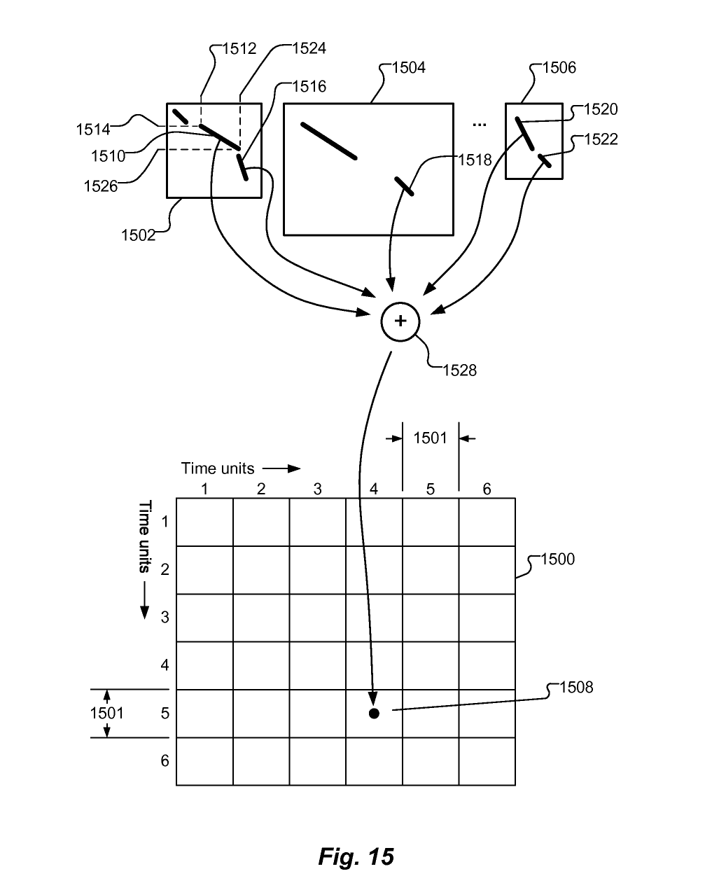

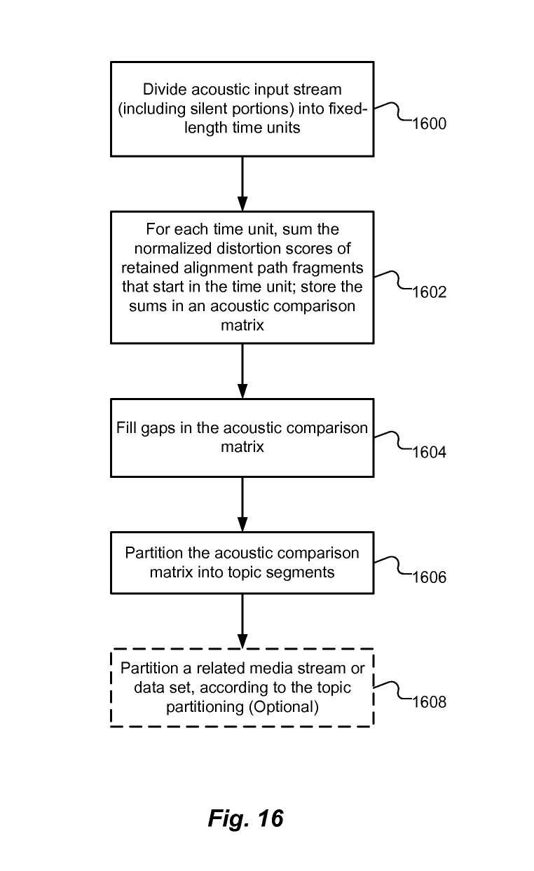

A process for generating an acoustic comparison matrix 1500 is illustrated schematically in FIG. 15 and is summarized in a flowchart in FIG. 16. The original acoustic input signal 100 (FIGS. 1 and 2) is divided into fixed-length time units. For example, a one-hour lecture may be divided into about 500 to about 600 time units of about 6 or 7 seconds each; however, other numbers and lengths of time units may be used. The fixed-length time units are generally, but not necessarily, longer than the silence-free utterances discussed above. Some of these time units may contain silence. As shown in FIG. 15, the acoustic comparison matrix 1500 is a square matrix. The horizontal and vertical axes both represent the fixed-length 1501 time units. The acoustic comparison matrix 1500 in FIG. 15 has only six rows and six columns for simplicity of explanation; however, an acoustic comparison matrix may have many more rows and columns.

Information from the alignment matrices is aggregated in the acoustic comparison matrix 1500. For example, information from alignment matrices 1502, 1504 and 1506 is aggregated and stored in a cell 1508 of the acoustic comparison matrix 1500. For each pair of time unit coordinates in the acoustic comparison matrix 1500, i.e., for each cell of the acoustic comparison matrix 1500, all the retained alignment path fragments that fall within that pair of time unit coordinates are identified. For example, assume the alignment matrix 1502 contains a retained alignment path fragment 1510 that begins at time coordinates (1512, 1514) that are within the time unit coordinates (4, 5) that corresponds with cell 1508. Similarly, assume retained alignment path fragments 1516, 1518, 1520 and 1522 also have begin-time coordinates that are within the time unit coordinates (4, 5) that correspond with cell 1508. These retained alignment path fragments 1510 and 1516-1522 are identified, and information from these alignment path fragments 1510 and 1516-1522 is aggregated into the cell 1508.

Optionally or alternatively, the alignment path fragments may be identified based on other criteria, such as their: (a) end times (i.e., whether the alignment path fragment end-time falls within the alignment matrix time unit in question; for example, alignment path fragment 1510 ends at time coordinates (1524, 1526)), (b) begin and end times (i.e., an alignment path fragment must both begin and end within the time unit to be identified with that alignment matrix time unit) or (c) having any time in common with the time unit. Thus, an alignment path fragment may contribute information to one or more acoustic comparison matrix cells. For simplicity, identified alignment path fragments are referred to as “falling within the time unit coordinates” of a cell of the acoustic comparison matrix 1500.

For all the retained alignment path fragments that fall within a cell of the acoustic comparison matrix 1500, the normalized distortion values for the alignment path fragments are summed, and the sum is stored in the cell of the acoustic comparison matrix 1500. For example, as indicated at 1528, the normalized distortion values of the alignment path fragments 1510 and 1516-1522 are summed, and this sum is stored in the cell 1508.

The remaining cells of the acoustic comparison matrix 1500 are similarly filled in with sums of normalized distortion values (“comparison scores”). Constructing the acoustic comparison matrix 1500 is summarized in the first portion of the flowchart of FIG. 16. At 1600, the acoustic input signal, including silent portions, is divided into fixed-length time units. At 1602, for each pair of time unit coordinates within the acoustic comparison matrix, the normalized distortion scores of retained alignment path fragments that fall within the time unit coordinates are summed, and the sum is stored in the acoustic comparison matrix in the appropriate cell.

### Anisotropic Diffusion

Despite aggregating information from the alignment path fragments, the acoustic comparison matrix 1500 (FIG. 15) is still too sparse to deliver robust topic segmentation. In one set of experimental data, only about 67% of the acoustic input stream is covered by alignment paths. However, the aggregated information includes regions of cohesion in the acoustic comparison matrix 1500 that may be enlarged by anisotropic diffusion, which is a process that diffuses areas of highly concentrated similarity to areas that are not as highly concentrated, generally without diffusing across topic boundaries. “Anisotropic” means not possessing the same properties in all directions. Thus, anisotropic diffusion involves diffusion, but not equally in all directions. In particular, the diffusion occurs within areas of a single topic, but generally not across topic boundaries.

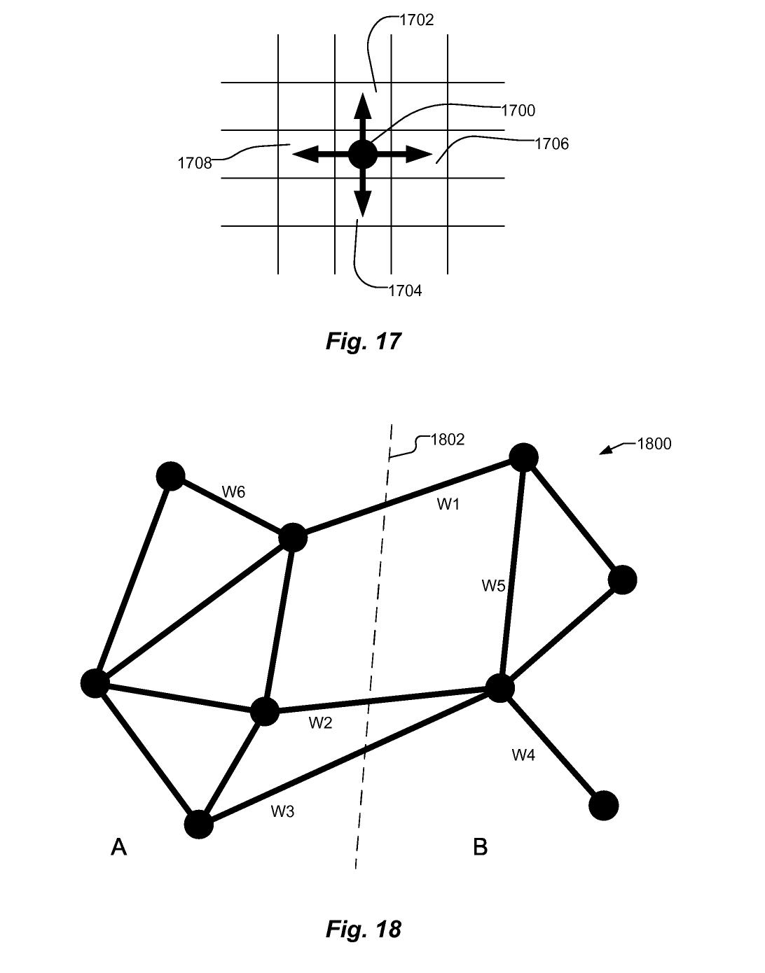

Anisotropic diffusion was originally based on the heat diffusion equation, which describes a rate of change in temperature at a point in space over time. A brightness or intensity function, which represents temperature, is calculated based on a space-dependent diffusion coefficient at a time and point in space, a gradient and a Laplacian operator. Anisotropic diffusion is discretized for use in smoothing pixelated images. In these cases, the Laplacian operator may be approximated with four nearest-neighbor (North, South, East and West) differences. FIG. 17 illustrates an example of anisotropic diffusion from a cell 1700 to the cell's nearest neighbors 1702, 1704, 1706 and 1708. Each neighbor's brightness or intensity is increased according to the brightness or intensity function.

Diffusion flow conduction coefficients are chosen locally to be the inverse of the magnitude of the gradient of the brightness function, so the flow increases in homogeneous regions that have small gradients. Thus, diffusion is preferential into cells that have similar values and not across high gradients. Flow into adjacent cells increases with gradient to a point, but then the flow decreases to zero, thus maintaining homogeneous regions and preserving edges. In discretized applications, such as the acoustic comparison matrix 1500 (FIG. 15), the process is iterative. Consequently, cells that have been diffused into during one iteration generally cause diffusion into their neighbors during subsequent iterations, subject to the above-described preferential action.

Anisotropic diffusion has been used for enhancing edge detection accuracy in image processing. (Perona and Malik, 1990.) In 3D computer graphics, anisotropic filtering is a method for enhancing image quality of textures on surfaces that are at oblique viewing angles with respect to a camera, where the projection of the texture (not the polygon or other primitive it is rendered on) appears to be non-orthogonal. Anisotropic filtering eliminates aliasing effects, but it introduces less blur at extreme viewing angles and thus preserves more detail than other methods.

The use of anisotropic diffusion in audio processing is counterintuitive, because diffusion of an audio signal would corrupt the signal. Although anisotropic diffusion has been used in text segmentation (Ji and Zha, 2003), text segmentation involves discrete inputs, such as words, whereas topic segmentation of an audio input stream deals with a continuous signal. Furthermore, text similarity is different than audio similarity, in that two fragments of text can be easily and directly compared to determine if they match, and the outcome of such a comparison can be binary (yes/no). On the other hand, two audio segments are not likely to match exactly, even if they contain identical semantic content. Thus, gradations of similarity of audio segments should be considered.

Speaker segmentation involves detecting differences between individual speakers (people). However, these differences are greater and, therefore, easier to detect than differences between topics spoken by a single speaker. Consequently, speaker segmentation may be accomplished without anisotropic diffusion. On the other hand, a single speaker may use identical words, phrases, etc. in different topics. Thus, in topic segmentation, utterances may be repeated in different topics, yet the acoustic comparison matrix is very likely to be sparse. In these cases, anisotropic diffusion facilitates locating topic boundaries.

Applying anisotropic diffusion to the acoustic comparison matrix 1500 reduces score variability within homogeneous regions of the acoustic comparison matrix 1500, while making edges between these regions more pronounced. Consequently, this transformation facilitates boundary detection. FIG. 5 contains a pixelated representation of an exemplary acoustic comparison matrix 500 for the physics lecture after 1,000 iterations of anisotropic diffusion. Filling the gaps in the acoustic comparison matrix 1500, such as by anisotropic diffusion or another set of transformations to refine the representation for topic analysis, is indicated at 1604 in the flow chart of FIG. 16.

### Partitioning

As noted, the coherent regions in the acoustic comparison matrix 500 (FIG. 5) are recursively grown through anisotropic diffusion until distinct, easily identifiable regions become apparent. Then, data in the acoustic comparison matrix 500 is partitioned into segments, according to distinctions between pairs of the grown regions, such as according to boundaries or spaces between the grown regions or where the outer edges of adjacent grown regions touch each other. The data in the acoustic comparison matrix 500 is partitioned in a way that maximizes intra-segment similarity and minimizes inter-segment similarity to yield individual topics, such as topics 502, 504 and 506, as indicated at 1606 (FIG. 16).

A normalized cut segmentation methodology is used to segment the data in the acoustic comparison matrix 500. (Shi and Malik, 2000; Malioutov and Barzilay, 2006.) The cells of the acoustic comparison matrix 1500 (FIG. 15) can be conceptualized as nodes in a fully-connected, undirected graph. That is, each matrix cell corresponds to a node of the graph, and each graph node is connected to every other node by a respective edge. Each edge has an associated weight equal to the degree of similarity between the two nodes connected by the edge. A portion 1800 of such a graph is depicted in FIG. 18. Exemplary edge weights W1, W2, W3, W4, W5 and W6 are shown. For simplicity of explanation, only a small number of nodes of the graph are shown, and some edges and weights are omitted.

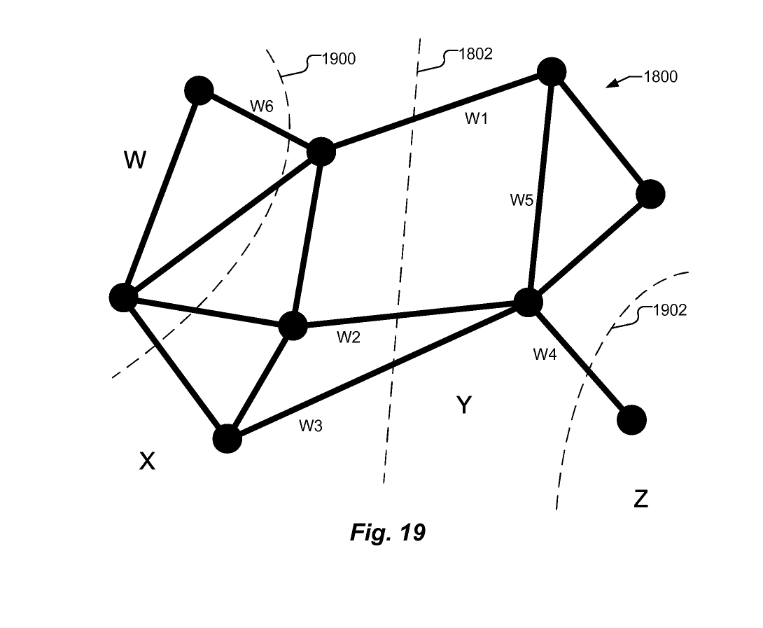

The graph may be partitioned by cutting one or more edges, as indicated by dashed line 1802, into two sub-graphs (also referred to as “clusters”) A and B, which is analogous to partitioning the data in the acoustic comparison matrix 1500 into two topic segments. The graph may be partitioned into more than two sub-graphs, as shown in FIG. 19, by cutting more than one set of edges. For example, in FIG. 19, the graph is partitioned into four sub-graphs W, X, Y and Z, as indicated by dashed lines 1802, 1900 and 1902.

Minimum cut segmentation would partition the graph so as to minimize the similarity between the resulting sub-graphs A and B or X, Y and Z. i.e., to minimize the sums of the weights of the cut edges. However, minimum cut segmentation can leave small clusters of outlying nodes, because the outlying nodes are not similar to the node(s) in any possible cluster. Using a normalized cut objective avoids this problem.

A “cut” is defined as the sum of the weights of the edges affected by the cut. For example, cut(A, B) is defined as the sum of the weights of the edges that are cut in order to partition the graph into sub-graphs A and B. Thus, for example, referring back to FIG. 18, cut(A, B)=W1+W2+W3.

A “volume” of a cluster of nodes is defined as the sum of the weights of all edges leading from all nodes of the cluster to all nodes of the graph. Thus, the volume is the sum of all outgoing and cluster-internal edge weights:

$$vol ( A , G ) = {\sum }_{u ∈ A , v ∈ V} w ( u , v ) \qquad ( 5 )$$

where A is the set of nodes in a cluster, G is the set of all the nodes of a graph, V is the set of all the edges (vertices) of the graph and w(u, v) is the weight associated with the edge between nodes u and v.

An “association” assoc(A, B) of a first cluster A to another cluster B is defined as the sum of all edge weights for edges that have endpoints in the first cluster A, including both cluster-internal edges and edges that extend between the two clusters A and B. The notation assoc(A) is sometimes used as a shorthand for assoc(A, A).

From these definitions, in can be seen that:

vol(A,G)=assoc(A,G)=cut(A,G)+assoc(A,A) (6)

The Normalized Cut Criteria Minimizes:

$$\frac{cut ( A , B )}{assoc ( A , G )} + \frac{cut ( A , B )}{assoc ( B , G )} \qquad ( 7 )$$

In equation (7), the cuts are normalized by the associations. Minimizing equation (7) jointly maximizes similarities within clusters and minimizes similarities across clusters by considering both weights between potential clusters and associations of each cluster with the rest of the graph.

Thus far, two-way partitioning of a graph has been described. However, an audio input stream may contain more than two topics. A generalization of the above-described normalized cut criterion, referred to as “n-way normalized cut” (Malioutov & Barzilay, 2006), may be used. The generalized methodology minimizes:

$$\frac{cut ( {A}_{1} , G - {A}_{1} )}{assoc ( {A}_{1} , G )} + … + \frac{cut ( {A}_{k} , G - {A}_{k} )}{assoc ( {A}_{k} , G )} \qquad ( 8 )$$

where A₁, A₂, . . . Aₖ are the clusters of nodes resulting from a k-way partitioning of graph G, and G−Aₖ is the set of nodes that are not in the cluster Aₖ.

The number of topics in an audio input stream may or may not be provided as an input into the system or via a heuristic. Given a desired or suggested number of topics, the system provides a best segmentation using the n-way normalized cut. Generating segmentations of the graph is fast and computationally inexpensive. Furthermore, generating an s-way segmentation generates segmentations for 2-way, 3-way, . . . s-way segmentations. Thus, the system may generate segmentations for 2, 3, 4, . . . s clusters and then choose an appropriate segmentation, without necessarily being provided with a target number of topics. A selection criteria may be used to select the appropriate segmentation. In one embodiment, the number of clusters is automatically chosen so as to minimize the “Gap statistic” (a measure of clustering quality) (Meil\check{a} and Xu, 2004, Tibshirani, 2000) between clusters. In another embodiment, the number of clusters is automatically chosen such that the number of clusters is as large as possible without allowing the number of nodes in any cluster to fall below a predetermined fraction of the total number of nodes in the graph. Other selection criteria, such as the Calinski and Harabasz index or the Krzanowski-Lai index may be used.

Optionally or alternatively, other unsupervised segmentation methods may be used. (Choi, et al., 2001; Ji and Zha, 2003; Malioutov and Barzilay, 2006.)

### Segmenting Another Medium According to Acoustic Topic Segmentation

Once the acoustic comparison matrix 500 is partitioned, start and/or end times of the partitions 508 and 510 may be used to segment the original acoustic input signal 100. If the original acoustic input signal 100 is part of, or associated with, another signal, the other signal may also be partitioned according to the partitions in the acoustic comparison matrix 500, as indicated at 1608 (FIG. 16). For example, if the original acoustic input signal 100 is an audio track of a multimedia stream, such as an audio/video stream or a narration of a set of presentation slides, the multimedia stream or one or more media components thereof may be partitioned according to the found topic boundaries. In one embodiment, a recorded television news broadcast or documentary is partitioned into individual audio/video segments, according to found topic boundaries. The individual audio/video segments may correspond to individual news stories within the broadcast, topics with the documentary, etc. The topic boundaries may correspond to dividing points between these news stories, between news and advertisements, and the like.

### Implementation

A system for partitioning an input signal into coherent segments, such as the system described above with reference to FIG. 2, may be implemented by a suitable processor controlled by instruction stored in a suitable memory. The memory may be random access memory (RAM), read-only memory (ROM), flash memory or any other memory, or combination thereof, suitable for storing control software or other instructions and data. Some of the functions performed by the disclosed systems and methods have been described with reference to block diagrams and/or flowcharts. Those skilled in the art should readily appreciate that functions, operations, decisions, etc. of all or a portion of each block, or a combination of blocks, of the block diagrams and/or flowcharts may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including computer networks. In addition, while the invention may be embodied in software, the functions necessary to implement the invention may alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. Moreover, while the embodiments are described in connection with various illustrative data structures, one skilled in the art will recognize that the system may be embodied using a variety of data structures. Furthermore, disclosed aspects, or portions of these aspects, may be combined in ways not listed above. Accordingly, the invention should not be viewed as limited.

What is claimed is:

1. A method for segmenting a one-dimensional first signal into coherent segments, the method comprising:
generating a representation of spectral features of the signal;
identifying a plurality of recurring patterns in the signal using the generated spectral features representation;
aggregating information about a distribution of similar ones of the identified patterns;
modifying the aggregated information to enlarge regions representing at least some of the similar identified patterns; and
partitioning the signal according to ones of the enlarged regions.

2. A method according to claim 1, further comprising:
partitioning the modified aggregated information according to ones of the enlarged regions; and
wherein partitioning the signal comprises partitioning the signal according to the partitioning of the modified aggregated information.

3. A method according to claim 1, wherein identifying the plurality of recurring patterns comprises:
for each of a plurality of pairs of the spectral feature representations, calculating a distortion score corresponding to a similarity between the representations of the pair; and
selecting a plurality of the pairs of spectral feature representations based on distortion scores and a selection criterion.

4. A method according to claim 3, wherein identifying the plurality of recurring patterns comprises optimizing a dynamic programming objective.

5. A method according to claim 1, wherein aggregating information about the distribution of similar identified patterns comprises:
discretizing the signal into a plurality of time intervals; and
for each of a plurality of pairs of the time intervals, computing a comparison score.

6. A method according to claim 1, wherein:
identifying the plurality of recurring patterns comprises, for each of a plurality of pairs of spectral feature representations of the signal, calculating an alignment score corresponding to a similarity between the representations of the pair; and
computing the comparison score comprises summing the alignment scores of alignment paths, at least a portion of each of which falls within one of the pair of the time intervals.

7. A method according to claim 1, wherein modifying the aggregated information to enlarge regions representing at least some of the similar identified patterns comprises reducing score variability within homogeneous regions.

8. A method according to claim 7, wherein reducing score variability within homogeneous regions comprises applying anisotropic diffusion filtering to a representation of the aggregated information.

9. A method according to claim 1, wherein partitioning the signal comprises applying a process that is guided by a function that maximizes homogeneity within a segment and minimizes homogeneity between segments.

10. A method according to claim 1, wherein partitioning the signal comprises applying a process that is guided by minimizing a normalized-cut criterion.

11. A method according to claim 1, further comprising partitioning a second signal, different than the first signal, consistent with the partitioning of the first signal.

12. A method according to any one of claims 1-10, wherein the first signal comprises an acoustic speech signal, and the generating, identifying, aggregating, modifying and partitioning are performed without access to a transcription of the acoustic speech signal.

13. A method according to claim 12, further comprising partitioning a second signal, different than the acoustic speech signal, consistent with the partitioning of the acoustic speech signal.

14. A method according to claim 13, wherein the second signal comprises a video signal.

15. A computer program product, comprising:
a computer-readable medium on which is stored computer instructions such that, when the instructions are executed by a processor, the instructions cause the processor to:
generate a representation of spectral features of the signal;
identify a plurality of recurring patterns in the signal using the generated spectral features representation;
aggregate information about a distribution of similar ones of the identified patterns;
modify the aggregated information to enlarge regions representing at least some of the similar identified patterns; and
partition the signal according to ones of the enlarged regions.

16. A system for partitioning an input signal into coherent segments, the system comprising:
a feature extractor operative to generate a representation of spectral features of the input signal;
a pattern detector operative to identify a plurality of recurring patterns in the signal using the generated spectral features representation;
a pattern aggregator operative to aggregate information about a distribution of similar ones of the identified patterns;
a signal transformer operative to modify the aggregated information to enlarge regions representing at least some of the similar identified patterns; and
a segmenter operative to partition the signal according to ones of the enlarged regions.
